(19) United States
(12) Patent Application Publication
(10) Pub. No.: US 2004/0194088 A1
(43) Pub. Date: Sep. 30, 2004

(54) Network device management

(76) Inventors: Jin-Rwei Chen, Nashua, NH (US); Vijay Subramanian, Billerica, MA (US)

Correspondence Address: C. Eric Schulman, Esq., Mintz, Levin, Cohn, Ferris, Glovsky and Popeo, PC, One Financial Center, Boston, MA, 02111-9976, US

(21) Appl. No.: 10/141,290

(22) Filed: May 8, 2002

(51) Int. Cl. G06F 9/46

(52) U.S. Cl. 718/100

(57) ABSTRACT

The present invention relates to systems and methods for bulk network device management. One embodiment of the invention provides a method for concurrently managing network devices including spawning a plurality of processes, e.g., threads. Each process or thread is associated with a network device. The plurality of processes or threads each invoke a program, e.g., an Expect engine, to execute a plurality of scripts, e.g., Expect scripts. Each script interfaces with the associated network device. The method further includes using each script to write information to a set of first log files. The information is the result of the execution of the script, which performs monitoring, configuration and fault management operations on the associated network device.

### FIELD OF THE INVENTION

The present invention relates to systems and methods for bulk network device management and, more particularly, to systems and methods for performing operations on network devices such as obtaining status information and logging the results of such operations.

### BACKGROUND OF THE INVENTION

Typically network management systems are product focused. When a network device vendor releases a new network device product, the device typically requires a proprietary network management system for the vendor's customers to manage the newly released device. In some cases, even different devices sold by the same vendor require different management systems. Thus, a need exists for a network management system framework that facilitates incorporation of newly released network devices whether the vendor that supplies the newly released device is the same or different from the pre-existing devices vendor(s).

Traditional network management systems primarily use the simple network management protocol (SNMP). SNMP manages network devices one at a time. According to SNMP, a network management system sends out a request and waits for a response. In the case of a large network, this protocol may consume significant bandwidth as network management communication according to SNMP increases network traffic.

More specifically, a network management system sends out SNMP requests one at a time for each MIB (Management Information Base) object being managed and waits for a response. An MIB is a set of parameters which a network management station can query or set in the network management agent of a network device, e.g., a router. In order to query many MIB objects to get the status of the managed network devices, there will be a large amount of SNMP request and response packages sent back and forth between the management system and managed devices. These packages generate a substantial amount of network traffic and consume network bandwidth. In addition, latency, i.e., the time involved in waiting for a response from a managed device, is a known problem of utilizing the SNMP protocol.

Furthermore, if a managed network device is overloaded, for example, by handling a large amount of incoming calls, the SNMP requests to be processed can become a burden to the device. Usually, if a network management system does not receive a response from a request within a timeout period, it resends the request. Thus, the management system can keep sending out SNMP requests before the expected response(s) arrive.

In addition, there are a variety of MIB objects that are poll-able such as the devices' up/down status and the devices' slot status. In the event of a fully loaded network device, processing the SNMP packages is usually a low-priority task for the device compared to its main functions. Thus, network device management using SNMP can degrade performance of the network and its constituent devices.

Having discussed SNMP, the network management protocol primarily used by traditional management systems, Expect is a programming language that can also be used to automate testing or management on individual network devices. For example, one application of Expect is the execution of an Expect script to run a file transfer protocol (FTP) program without user interaction. In other words, Expect is a program to control interactive applications. Interactive applications prompt a user and expect the user to enter keystrokes in response to the prompt. By using Expect, one can write simple scripts to automate this process. Despite the existence of SNMP and Expect, a need remains for network management systems with improved performance and reduced latency and for a network management system framework that facilitates incorporation of newly released network devices.

### SUMMARY OF THE INVENTION

The present invention relates to systems and methods for bulk network device management. One aspect of the invention provides a method for concurrently managing network devices including spawning a plurality of processes. In one embodiment the processes are tasks or threads. Each thread is associated with a network device. The plurality of processes, e.g., threads, each invoke a program that automates (removes user interaction from) the procedure for spawning a process for interacting with a network device. As an example, a plurality of threads can invoke an Expect engine to execute a plurality of Expect scripts. Each script, written in Expect, performs a specific task customized for a particular type of network device. However, the present invention contemplates the use of any program, in addition to Expect, that automates the procedure for spawning a process for interacting with a network device. Examples of protocols that facilitate logging into and interacting with a remote computer or network device include telnet, file transfer protocol (FTP), and TFTP.

One can design a script to perform any of a variety of network management functions including gathering information for statistical analysis or performing any management operation such as configuring or maintaining a network device. The plurality of processes, e.g., threads, each execute the same script in parallel, i.e., concurrently, on a group of targets by invoking the Expect engine or similar program. Each script interfaces with an associated network device. The method further includes using each script to write information to a set of first log files. The information is related to the interface between each script and the associated network device.

Thus, embodiments of the invention facilitate the management of different types of network devices. For example, a system administrator can switch a management system according to the invention from managing a first set of devices to managing a second set of devices by simply replacing a first set of scripts with a second set of scripts on the network management system's file system. Programmer(s) program(s) the second set of scripts to apply to the second set of network devices. There is no need to recompile the management system.

According to a multithreading aspect of embodiments of the invention, the spawning of a plurality of threads can include spawning a plurality of threads up to a pre-selected number of threads. This number is set to avoid over utilizing the system resources. If the number of targeted network devices is greater than the pre-selected number, the method can maintain network device queue elements in a queue. The network device queue elements include information related to any targeted network devices for which threads have not yet been spawned. If a thread completes executing an Expect script for an associated network device such that the number of threads is less than the pre-selected number, the method removes a network device queue element from the queue and spawns a thread for the removed network device queue element. If the queue is empty and each thread has completed executing an Expect script for its associated network device, the method, according to one embodiment, includes spawning a consolidation thread. The consolidation thread invokes an Expect engine to execute a consolidation Expect script and the consolidation Expect script consolidates the first set of log files into a consolidated log file.

Another aspect of the invention provides a network management system for concurrently managing network devices. The system includes a module for spawning a plurality of processes. Each process is associated with a network device. The number of processes spawned at one time is limited to a pre-selected number. The plurality of processes each invokes a program to execute a plurality of scripts. Each script interfaces with an associated network device. As noted above, in one embodiment, the processes are threads and the threads invoke an Expect engine to execute a plurality of Expect scripts.

The system can further include a module for maintaining network device queue elements in a queue. The network device queue elements include information related to any targeted network devices for which processes have not yet been spawned. The network device queue elements are created if the number of targeted network devices is greater than the pre-selected number. The system also includes a module for removing a network device queue element from the queue and spawning a process for the removed network device queue element if an already existing process completes executing a script for an associated network device such that the number of processes is less than the pre-selected number.

Thus, embodiments of the invention, utilize an Expect engine or other program to execute scripts that automate network management methods in an efficient manner. Embodiments of the invention provide a framework for concurrently managing different network devices. One only needs to write a different script in order to manage a different network device, e.g., a new router or switch. As long as a network device supports a telnet, Command Line Interface (CLI), FTP, and TFTP, a network management system according to the present invention, once launched, does not require human intervention to manage the device.

Depending on the type of device the system is managing the user can replace one set of scripts for another set of scripts. In other words, one version of the invention provides a framework that allows the system to manage a variety of different network devices, such as various routers and switches, simply by utilizing appropriate scripts for the managed device(s).

### BRIEF DESCRIPTION OF THE ILLUSTRATED EMBODIMENTS

For a better understanding of the present invention, reference is made to the drawings, which are incorporated by reference and in which:

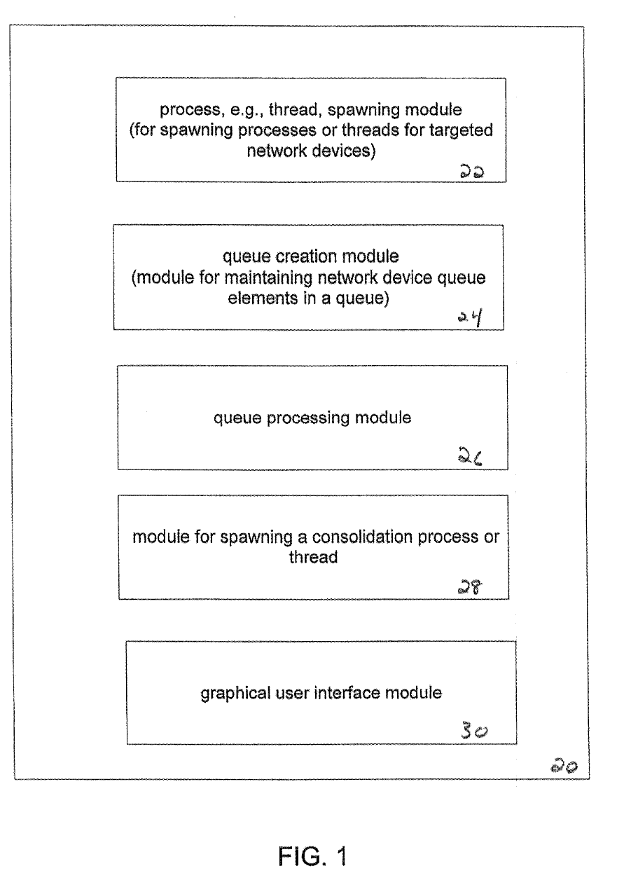

FIG. 1 is schematic diagram illustrating modules according to one embodiment of the present invention;

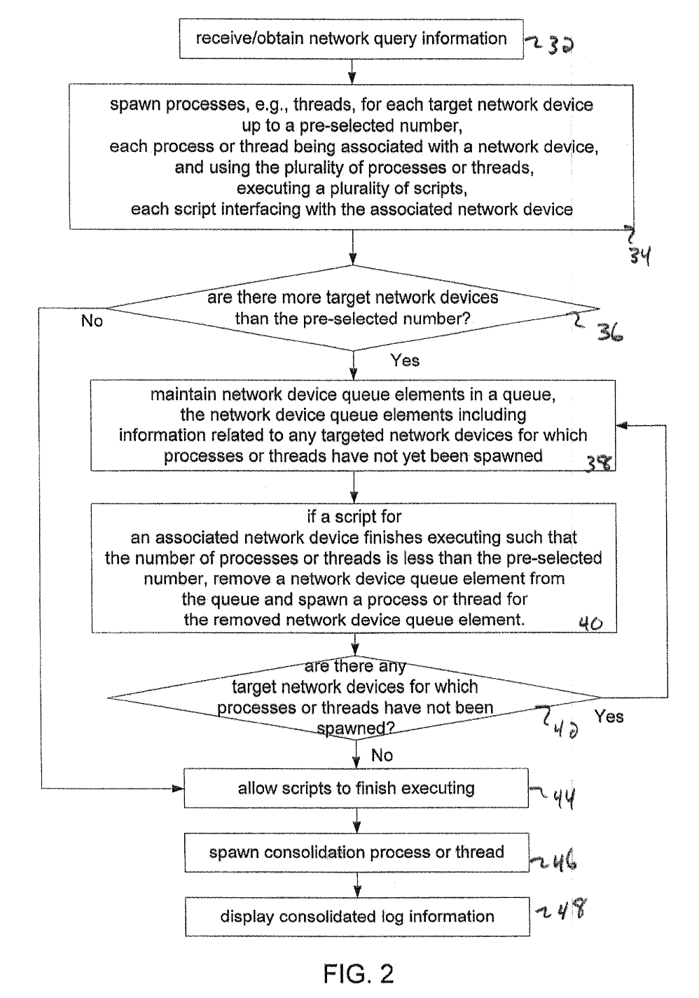

FIG. 2 is a flow chart for one embodiment of a method according to the present invention;

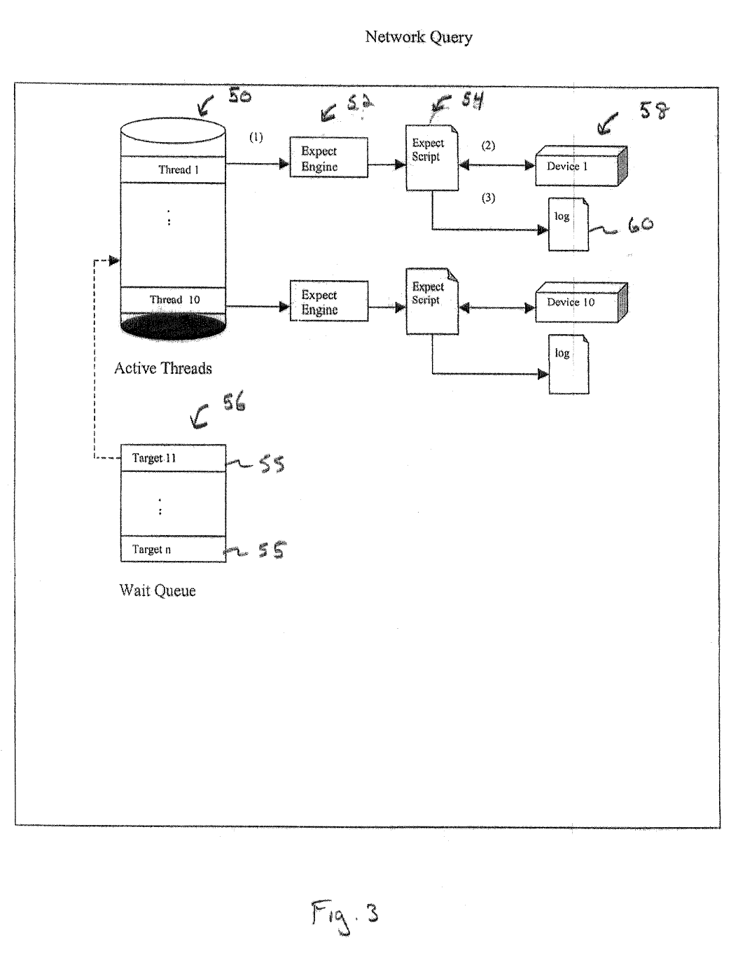

FIG. 3 is a schematic illustration of threads, spawned by an embodiment of the invention as illustrated in FIG. 1, invoking an Expect engine to execute Expect scripts for interfacing with network devices;

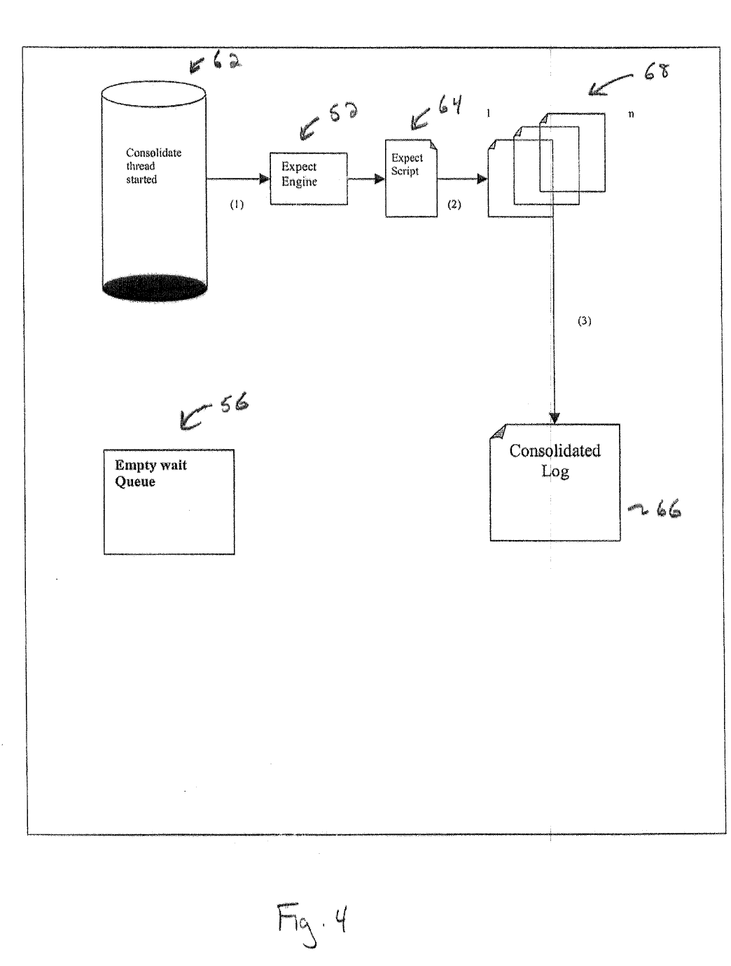

FIG. 4 is a schematic illustration of a consolidation thread, spawned by an embodiment of the invention as illustrated in FIG. 1, invoking an Expect engine to execute an Expect script for consolidating a set of first logs written by the Expect scripts of FIG. 3;

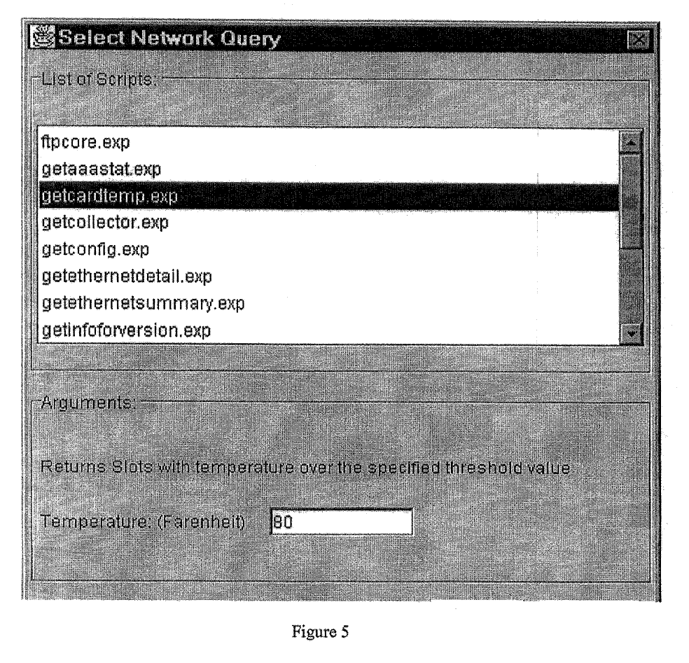

FIG. 5 is a screen shot of one embodiment of a graphical user interface for allowing a user to select a network query for execution as illustrated in FIG. 3 by one embodiment of the invention;

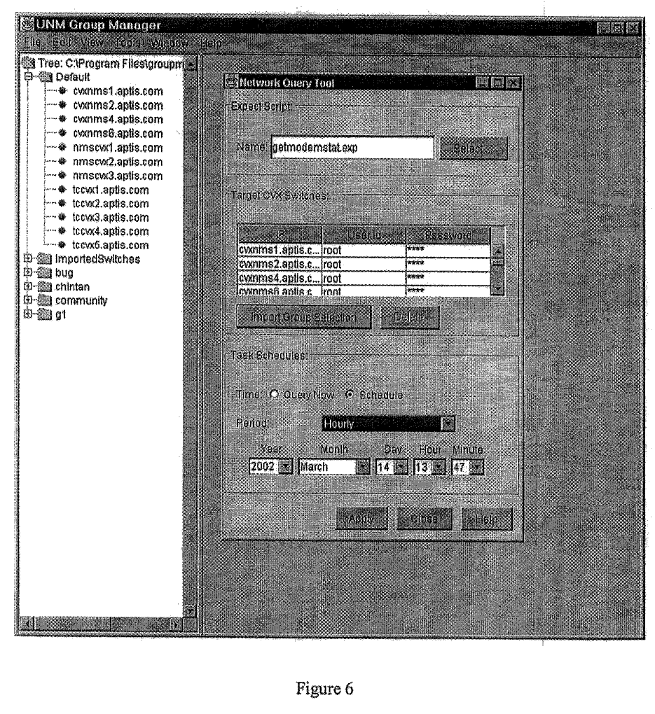

FIG. 6 is a screen shot of one embodiment of a graphical user interface for customizing and scheduling a network query for execution as illustrated in FIG. 3 by one embodiment of the invention;

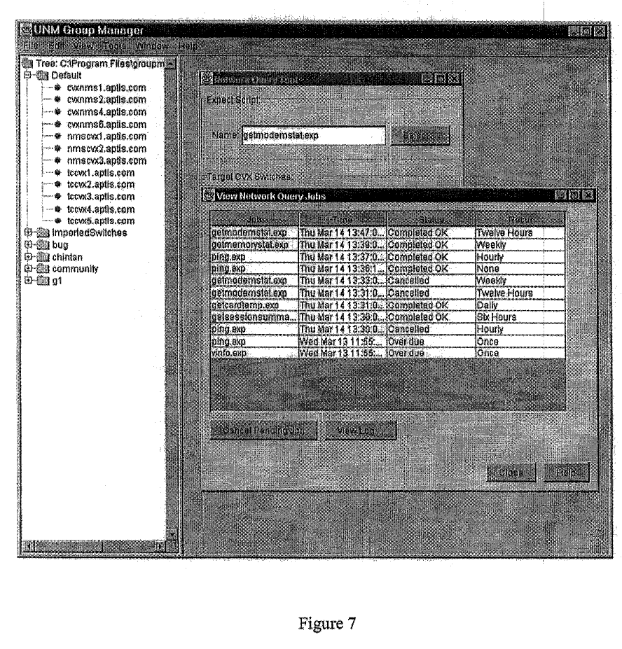

FIG. 7 is a screen shot of one embodiment of a graphical user interface for viewing the status of execution of a network query, the network query being executed as illustrated in FIG. 3 by one embodiment of the invention; and

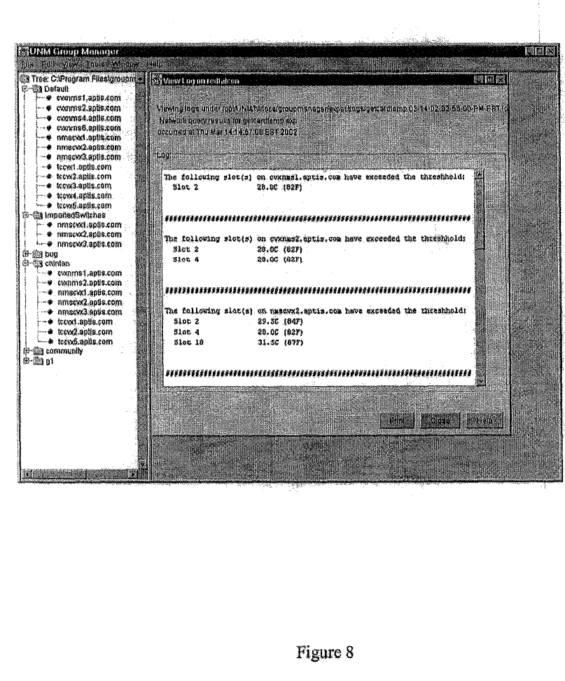

FIG. 8 is a screen shot of one embodiment of a graphical user interface for displaying the consolidated log file produced as a result of the process illustrated in FIG. 4.

### DETAILED DESCRIPTION OF THE INVENTION

The present invention relates to systems and methods for bulk network device management. In contrast to package-based SNMP, embodiments of the invention use a variety of connection-oriented protocols, including Telnet, file transfer protocol (FTP), and trivial FTP (TFTP), to manage network devices. The connection is maintained for a short time and the management system can achieve its goal in a timely fashion. Furthermore, embodiments of the invention manage a group of network devices concurrently.

With reference to FIGS. 1 and 3, one embodiment of the invention provides a network management system 20 for concurrently managing network devices. The system includes a module 22 for spawning a plurality of processes, e.g., threads 50. Each process or thread 50 is associated with a network device 58. In the illustrated embodiment, the number of processes or threads spawned at one time is limited to a pre-selected number, e.g., 10.

Thus, the present invention contemplates the spawning of a plurality of processes. In one embodiment, the processes are threads. Multithreading can be used for very fine-grain multitasking, at the level of a few instructions, and so can hide latency by keeping the processor busy after one thread issues a long-latency instruction on which subsequent instructions in that thread depend.

Returning to FIGS. 1 and 3, the plurality of processes, e.g., threads 50, each invoke a program, e.g., an Expect engine 52, to execute a script, e.g., an Expect script-54. Each script, e.g., Expect script 54, interfaces with the associated network device 58. In the illustrated embodiment, each Expect script 54 writes information to a log file 60. The information written to the log files 60 relates to the interface between each Expect script 54 and the associated network device 58. More generally, the plurality of processes each invokes a program that automatically executes a script for interacting with an associated network device.

The system 20 further includes a module 24 for maintaining network device queue elements 55 in a queue 56. The network device queue elements 55 include information related to any targeted network devices, e.g., targets 11 to n, for which processes, e.g., threads 50, have not yet been spawned. The system automatically creates the network device queue elements 55 if the number of targeted network devices 58 is greater than the pre-selected number. The system also includes a module 26 for removing a network device queue element 55 from the queue 56 and spawning a process or thread 50 for the removed network device queue element 55. The module 26 acts if an already existing process or thread 50 completes executing a script, e.g., an Expect script 54, for an associated network device 58 such that the number of processes or threads 50 is less than the pre-selected number.

With reference to FIGS. 1 and 4, the system 20 can also include a module 28 for spawning a consolidation process or thread 62. In the illustrated embodiment, the module 28 spawns a consolidation thread 62 if the queue 56 is empty and each thread 50 (shown in FIG. 3) has completed executing an Expect script 64 for its associated network device 58. The consolidation thread 62 invokes Expect engine 52 to execute a consolidation Expect script 64, and the consolidation Expect script 64 consolidates the first set of log files 68 into a consolidated log file 66.

The system 20 further includes a graphical user interface (GUI) module 30. The GUI module allows a user to interact with the system in a variety of ways. FIGS. 5-8, discussed below, expand on the operation of embodiments of the GUI module 30.

With reference to FIGS. 2 and 3, one embodiment of a method according to the invention receives/obtains 32 network query information. The method then concurrently spawns 34 processes, e.g., threads 50, for each target network device 58 up to a pre-selected number of processes or threads 50. In the illustrated embodiment, each thread 50 is associated with a network device 58. The plurality of threads 50 each invokes an Expect engine 52 to execute a plurality of Expect scripts 54. Each Expect script 54 interfaces with the associated network device 58.

The method then determines 36 whether there are more target devices than the pre-selected number. If not, the method simply allows completion 44 of the execution of the scripts, e.g., Expect scripts 54, associated with the existing processes or threads 50. If so, the method maintains 38 network device queue elements 55 in a queue 56. The network device queue elements 55 include information related to any targeted network devices 58 for which processes or threads have not yet been spawned. If a script, e.g., an Expect script, for an associated network device finishes executing such that the number of active processes or threads is less than the pre-selected number, the method removes 40 a network device queue element 55 from the queue 56 and spawns a process or thread 50 for the removed network device queue element 55.

The method then determines 42 if there are any target network devices for which processes or threads have not been spawned. If so, the method returns to maintaining 38 network device queue elements in a queue. If not, the method allows completion 44 of the existing scripts.

Finally, with reference to FIGS. 2 and 4, the method can include spawning 46 a consolidation process or thread 62 once the queue 56 is empty and all the prior scripts, e.g., Expect scripts 64, have finished executing. Upon completion of the script, e.g., Expect script, executed by a program, e.g., an Expect engine 52, invoked by the consolidation process or thread 62, the method can display 48 consolidated log information.

Thus, embodiments of this invention can utilize a mechanism for spawning multiple concurrent threads provided by Java. However, other programming languages such as C and C++ also provide such a mechanism and are capable of being used with the invention. As a result, the present invention makes the processing provided by the network management system faster than traditional management systems by the number of threads that are spawned, e.g., 10. Alternatively, the present invention can utilize multiprocessing instead of multithreading. However, multiprocessing is a more costly approach than multithreading because of the need for more processing resources.

One embodiment of the invention spawns individual processes or threads to execute individual scripts, e.g., Expect scripts, for each target device. Each of these processes or threads supplies an associated script, e.g., an Expect script, with relevant information required by the script for it to interact with the target device. The information provided to the program, e.g., the Expect process, can include the IP or Hostname of the network device, a user name, a password and other parameters if needed.

In one embodiment, each Expect process uses the relevant command line interface (CLI) commands on the target device, and then retrieves and parses the resulting information. The Expect process can write the formatted output to a temporary log file.

Finally, embodiments of the invention spawn a consolidation process or thread that invokes a script, e.g., an Expect script, to concatenate all the individual log information to one log file for that batch of devices.

If the number of target devices is more than a pre-selected number, e.g., ten, the spawned processes or threads are limited to that pre-selected number. The system puts the remaining target devices in a wait queue. At any point of time, when an active process or thread has completed processing, and if there is any target device element remaining in the wait queue, the system spawns a new process or thread for a device remaining in the wait queue. The total number of processes or threads that the system spawns directly depends on the management system's resources. Embodiments of the invention impose a limit to avoid overloading the management system's resources.

With reference to FIGS. 5-8, embodiments of the invention also provide a graphical user interface (GUI) front end that allows a user to select a specific script, e.g., Expect script, to execute the script, schedule the execution of the script, display the execution status, and view the consolidated log file. With reference to FIGS. 1 and 5, the GUI module 30 of the system 20 provides a select network query screen. A user can use this screen to select a network query, e.g., an Expect script, to execute, such as getcardtemp.exp. The user can also enter relevant arguments, such as a threshold temperature for targeted slots. Although getcardtemp.exp is the script selected in this example, the invention contemplates a variety of scripts for performing a variety of operations for obtaining network device status information and a variety of scripts for configuring network devices. For example, other scripts listed in FIG. 5 include getconfig.exp and getethernetsummary.exp.

With reference to FIG. 6, the GUI module provides a network query tool (NQT) screen. The NQT screen displays the selected script name and the IP address, user identification, and password for selected or targeted network devices, such as CVX switches. The NQT screen allows the user to select another script, edit the target network device list and schedule the execution of the script. For example, a user can enter a start date and time and recurrence parameters.

With reference to FIG. 7, the GUI module provides a view network query jobs (VNQJ) screen. This screen allows a user to view the execution status of an executing script.

With reference to FIG. 8, the GUI module provides a view log screen for an executed script. The view log screen provides a consolidated log of the results of the execution of a selected script. The illustrated screen shots provide only illustrative embodiments of the invention. The invention contemplates a variety of graphical user interfaces capable of allowing a user to interact with the network management system of the invention.

Network management systems according to embodiments of the invention are generic, enabling them to support a variety of network devices. These systems provide easy-to-comprehend graphical user interfaces. These systems are also scalable. These systems can take into account the number of devices being managed, the type of management function to be performed and the type of device to be managed. Depending upon the type of device that the system is intended to manage, a set of device specific scripts can be plugged into the framework of the system and the system can execute the scripts without further customization of the system framework.

With reference to FIGS. 3 and 4, the following are specific elements that facilitate bulk network management according to embodiments of the invention:

1) Concurrent processes or threads 50: As noted above, each process or thread 50 invokes a program, e.g., the Expect engine 52, to execute a script 54 for a particular target device 58. One of the responsibilities for each of these processes or threads 50 is to hand over necessary information to the program, e.g., Expect engine 52, which executes the script 54 using this information. The information includes the IP address or host name of the target device 58, a user name, a password and other parameters needed by the script 54. These processes or threads 50 can also update a user interface with the execution status on a per target basis.

2) Queue 56: Embodiments of the invention spawn processes or threads 50 to launch a program, e.g., the Expect engine 52, for the first pre-selected number of target devices 58. The remaining target device information (if any) is kept in a wait queue 56. When an active process or thread 50 has completed executing the script 54 for one target 58, a queue element 55 is removed from the wait queue 56 and a process or thread 50 is started for the queue element 55. This procedure continues until there are no more elements 55 available in the wait queue 56.

3) A program for automating the procedure for spawning a process for interacting with an associated network device, e.g., use of an Expect engine 52: Embodiments of a system according to the invention make use of the Expect engine 52, e.g., version 5.32, that can automate interactive applications using Telnet, FTP, and TFTP. The functionality of the Expect engine 52 is known in the art.

4) Scripts, e.g., Expect scripts 54: Scripts 54 obtain required information from the processes or threads 50 such as the IP address or host names of target device 58, a user name, a password and any other parameters if needed. For example, an Expect script 54 establishes a Telnet, FTP or a TFTP connection to the target device 58 and performs at least one specific function. The functions may include performing monitoring of, configuration of, and performance and fault management on the target device 58. The Expect scripts 54 execute appropriate commands, provided by the command line interface, on the target device 58. The Expect scripts 54 also extract and parse relevant information and write the relevant information to individual temporary log files 60. Finally, the Expect scripts 54 gracefully exit the connection established with the target device 58.

5) Consolidation routine 62: Embodiments of the invention spawn a separate consolidation process or thread 62 that performs clean-up operations. The consolidation process or thread 62 executes a separate consolidation script 64 that merges the individual log files 68 into one formatted log file 66 that can be viewed via a graphical user interface. The consolidation script 64 can also remove all the temporary log files that were created by each of the processes or threads associated with network devices 58.

This invention provides a framework for the efficient management of any type of network device that supports protocols for interactive communication such as Telnet, FTP or TFTP. Embodiments of a framework according to the invention allow the addition of a new network device to the management system simply by plugging in a script, e.g., an Expect script, that performs the specific task on the newly added device. As noted earlier, a variety of network management tasks can be accomplished concurrently by using this invention including monitoring, configuration, performance and fault management. Embodiments of the invention also provide a generic, simple, and easy-to-understand display for the output of the scripts employed.

Having thus described illustrative embodiments of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. A method for managing network devices, the method comprising:
concurrently spawning a plurality of processes, each process being associated with a network device; and
using the plurality of processes, executing a plurality of scripts, each script managing an associated network device.

2. The method of claim 1, wherein the processes are threads.

3. The method of claim 2, wherein the scripts are Expect scripts.

4. The method of claim 2, wherein the method further comprises:
prior to spawning a plurality of threads, displaying a graphical user interface for selecting a network query and, responsive to displaying the graphical user interface, receiving selected network query data: and
wherein spawning a plurality of threads is based on at least in part on the selected network query data.

5. The method of claim 4, wherein displaying a graphical user interface for selecting a network query comprises:
displaying a graphical user interface for scheduling execution of the selected query.

6. The method of claim 3, wherein each of the threads provides information to each of the Expect scripts allowing each Expect script to interface with an associated network device without requiring a user to intervene.

7. The method of claim 6, wherein the information provided to the Expect script includes a user name, a password, and at least one of the IP address and the hostname of the network device.

8. The method of claim 3, wherein the method further comprises: using each Expect script, writing information to a set of first log files, the information being related to the interface between each Expect script and the associated network device.

9. The method of claim 8, wherein spawning a plurality of threads comprises spawning a plurality of threads up to a pre-selected number of threads and wherein the method further comprises:
if the number of targeted network devices is greater than the pre-selected number, maintaining network device queue elements in a queue, the network device queue elements including information related to any targeted network devices for which threads have not yet been spawned; and
if an Expect script for an associated network device finishes executing such that the number of threads is less than the pre-selected number, removing a network device queue element from the queue and spawning a thread for the removed network device queue element.

10. The method of claim 9, wherein the method further comprises:
if the queue is empty and each thread has completed executing an Expect script for its associated network device, spawning a consolidation thread;
using the consolidation thread, executing a consolidation Expect script; and
using the consolidation Expect script, consolidating the first set of log files into a consolidated log file.

11. The method of claim 10, wherein the method further comprises:
deleting the first set of log files.

12. The method of claim 10, wherein the method further comprises:
providing the consolidated log file for viewing.

13. The method of claim 1, wherein each process invokes a program that automates the procedure for spawning a process for interacting with an associated network device.

14. The method of claim 3, wherein each thread invokes an Expect engine, the Expect engine executing each Expect script for each associated network device.

15. The method of claim 3, wherein the Expect scripts perform at least one of a monitoring function, a configuration function, and a performance and fault management function.

16. A network management system for managing network devices, the system comprising:
means for spawning a plurality of processes, each process being associated with a network device, the number of processes spawned at one time being limited to a pre-selected number, the plurality of processes causing the execution of a plurality of scripts, each script interfacing with the associated network device;
means for maintaining network device queue elements in a queue, the network device queue elements including information related to any targeted network devices for which processes have not yet been spawned; the network device queue elements being created if the number of targeted network devices is greater than the pre-selected number; and
means for removing a network device queue element from the queue and spawning a process for the removed network device queue element if an already existing process completes executing a script for an associated network device such that the number of processes is less than the pre-selected number.

17. The system of claim 16, wherein the processes are threads, wherein the scripts are Expect scripts and wherein each of the threads provides information to each of the Expect scripts allowing each Expect script to interface with its associated network device.

18. The system of claim 17, wherein each Expect script establishes a connection between the network management system and the Expect script's associated network device.

19. The system of claim 16, wherein the network devices support telnet access.

20. The system of claim 16, wherein the network devices support FTP.

21. The system of claim 16, wherein the network devices support CLI (Command Line Interface).

22. The system of claim 17, wherein the system further comprises:
means for spawning a consolidation thread if the queue is empty and each thread has completed executing an Expect script for its associated network device, the consolidation thread causing the execution of a consolidation Expect script, and the consolidation Expect script consolidating the first set of log files into a consolidated log file.

23. A method for managing network devices, the method comprising:
spawning a plurality of processes based on a network query;
using the plurality of processes, executing a plurality of scripts, each script interfacing with an associated network device, each of the processes providing information to each of the scripts allowing each script to interface with its associated network device.

24. The method of claim 23, wherein the method further comprises:
determining execution status of the network query; and
providing the execution status for viewing.
